(19) United States
(12) Patent Application Publication
(10) Pub. No.: US 2017/0215503 A1
(43) Pub. Date: Aug. 3, 2017

(54) Safety Surface Materials

(71) Applicant: William H. McGrath, JR., Whiting, NJ (US)

(72) Inventor: William H. McGrath, JR., Whiting, NJ (US)

(21) Appl. No.: 15/011,927

(22) Filed: Feb. 1, 2016

(51) Int. Cl. A41G 1/00; B32B 25/04; A63G 31/00; B32B 27/32

(52) U.S. Cl. CPC A41G 1/009; B32B 27/32; B32B 25/04; A63G 31/00; B32B 2307/558; B32B 2307/71; B32B 2307/712

(57) ABSTRACT

A safety surface material for a playground facility employing a monolithically mixed and trowelable thermoplastic olefin urethane cushion base course layer—which, for water park/spray park use is overlain by a thermoplastic rubber wear top course layer that is both light stable and chlorine resistant.

### CROSS-REFERENCE TO RELATED APPLICATIONS

None.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

Field of the Invention

This invention relates to safety surface materials for playgrounds and water parks, in general, and to such surface materials as are “environmentally friendly”, in particular.

Description of the Related Art

As will be appreciated, playground-themed recreational facilities are required to satisfy prescribed safety regulations which are not applicable to such water-themed recreational facilities as spray parks. Specifically, the playground facility surfaces are required to meet recognized standards including those issued by the American Society For Testing And Materials (ASTM) which establish play area requirements for children ages 2 and over, and which cover separate play areas within a site for specific age groups—but not the water park/spray park facility surfaces Such standards typically establish three criteria that need to be addressed to assess functionality: a) the force of impact from a fall in a use zone in and around playground equipment; b) the accessible routes in and around the playground equipment designed for circulation around the equipment and on whose surfaces it is predicted that a user would land when falling from or exiting pertinent play structures or equipment; and c) the surface characteristics of playground surfaces that allow for compaction, propulsion and turning capabilities for mobility devices on playground surfaces.

As will be understood, this has given rise to different specifications for different types of playground surfacing materials, such as: loose fill; pea gravel, sand and wood chips; shredded rubber and engineered wood fiber—and such fully accessible surfaces as pour-in-place rubber mats/tiles, and artificial grass with rubber in-fill.

As will be recognized by those skilled in the art, those safety surfaces installed by schools, parks or cities that are investing in a new playground, commonly employ a cushioned course or base surface layer, overlain by a wear course layer to keep safety, accessibility and user integration in mind. Comparisons are nevertheless often made between the consideration of the cost of installation and maintenance and the height of the equipment and the ages of the users, together with the amounts of their use. Less considerations have been observed to be given to the life expectancy of the surface and infill materials, and to the dispersion of accessible elements of the safety surfaces—and substantially little consideration has been given to the implementation of such surfaces in water splash park and spray park constructions.

Most playgrounds installed today utilize a wear course layer of granulated synthetic vulcanized rubber Ethylene Propylene Diaene Monomer (EPDM) over a cushion course layer of Styrene Butylene Rubber (SBR) formed of recycled, ground-up tire particles bound together with a polyurethane binder. Experience has shown, however, that these EPDM rubber pieces break down relatively fast under ultraviolet light—to the extent of even turning “white” within just a few weeks of placement. With available sunlight tending to break down the rubber itself, the associated surface then becomes brittle, leading to quick disintegration. In playground areas, the usual “fix” is just to sweep away the broken pieces and resurface the area every few years. Alternatively, a spraying may be done with a pigmented urethane every 1-2 years, with the urethane having various rubber fines in it in an attempt to bind the surface back together. Using trowels and lubricating solvents to smooth the repaired surface quickens the breakdown process, however, as the EPDM granules are attacked by the types of sprays employed. With these vulcanized rubber pieces being totally unrecyclable, the disintegrated pieces can only be trucked to a landfill and dumped. But, as important as this may be, maintenance of these surfaces are sparse, and surface conditions are allowed to deteriorate over time. And, the same breakdowns under environmental conditions have been known to exist with the SBR underlying base layer.

Moreover, serious concerns have also been raised as to adverse “health considerations” associated with the employment of the Styrene Butylene Rubber as the cushioning course base. Such concerns as to its relationship to “asthma”, for example, have even prompted the ripping up of installed playgrounds in England to get rid of the SBR, and to no longer use it—using instead a foam mat underneath. But experience has shown that such substitution has led to problem of its own, as the mats tend to shrink and expand with temperature changes, worsening over time, tearing the wear layer, and any grass or artificial turf installed on top of that.

In any respect, depending upon use, and the type of playground equipment set up (be it swings, monkey bars, seesaw tetter-totters, or whatever) the SBR base employed is commonly anywhere from 2″-4″ thick, with the overlying EPDM layer typically some ¾″ thick. For an 8 foot drop height with a G-Force of some 200 or less, a 3″ thick SBR cushion has generally been accepted as the ASTM standard—with increasing thicknesses being required for greater drop height satisfactions.

While “drop heights” and “G-Force” standards have not been established with respect to water parks and spray parks, investigation and research has revealed that many instances of injury have been sustained there through falls of children running and jumping along its wet surfaces. The employment of a granulated synthetic rubber surface of EPDM is not generally recommended there—as besides being light sensitive, such surfaces are not chlorine resistant, but break down just as they do through exposure to ultraviolet sunlight. Furthermore, the use of Styrene Butylene Rubber has been determined to be of limited use in that environment also, as the constant wetness experienced at these recreational facilities similarly erodes the rubber tire particles over time. In such regard, however, is a savings grace of the water-themed recreational facility not being exposed to an insurance company defense that drop height standards were not met when sued for injuries suffered by nature of falls at playground locations where the surface has deteriorated. As to this, it will be understood by those skilled in the art that an insurance company typically in answering a claim on a playground fall first proceeds by having tests run to see if the drop height/G-Force standard was maintained—and if not, disclaiming the defense of, and liability assumption of, a defendant then being sued by virtue of such circumstances.

### OBJECTS OF THE INVENTION

It is an object of the present invention to provide a new and improved safety surface material for use in playground constructions and installations.

It is an object of the invention, also, to provide such a safety surface material which can also serve as a safety surface material for water parks and spray parks.

It is an object of the invention, additionally, to provide these safety surface materials of a less expensive nature than those associated with the construction and maintenance of prior art surfaces—while, at the same time, offering enhanced benefits against fall and sliding injuries of the kinds previously associated at these locations.

And, it is yet a further object of the invention to provide a safety surface material Of this type which, by itself, is recyclable after use.

### SUMMARY OF THE INVENTION

As will become clear from the following description, the safety surface materials of the present invention incorporate a monolithically mixed and trowelable thermoplastic foamed thermoplastic olefin cushion base course and urethane binder layer overlain by a thermoplastic rubber wear top course layer that is light stable, and for water use is also chlorine resistant.

### BRIEF DESCRIPTION OF THE DRAWING

FIG. 1 is a block diagram helpful in an understanding of the safety surface materials of the invention.

### DETAILED DESCRIPTION OF THE INVENTION

As will be appreciated, one of the more developing recreational facilities of late has been the construction of water parks—and particularly water spray parks in large facilities likened in size to commercial malls. Recognizing that some things other than bare concrete is needed on which kids and children run about, EPDM layers have been proposed, and are being utilized, instead as a covering material. Problems with these granulated synthetic rubber surfaces have been recognized, however, as in US Patent Application Publication 2005/0245681—which proposed instead a formulation termed “Pebble-Flex” as an alternative usage. As its name implies, however, the formulation employed a composition in the form of “pebbles” which by their rounded-type appearance provided a limited ability to join in contact with one another. As a result, its advantages diminished over time, permitting sliding and hydroplaning as the kids and children ran about, especially when the surfacings were very wet.

Appreciating, furthermore, the need to maintain the active surface as being light stable, unaffected by ultraviolet light, as well as chlorine resistant, it goes without saying that any substitute surfacing exhibiting these characteristics, should also not degrade or readily break off, but have a meaningful life.

Forward thinking, as with the present invention, led to the conclusion that overall protection should be had, more than just dealing with such minor matters as bruised and scraped bodies, alms and legs when sliding or falling. Although recognizing that ASTM type standards have not so far been determined to apply to water and spray park operations, the present invention proceeds upon the benefits of these standards being satisfied as well.

Thus, in accordance with the present invention, a new and improved cushion based course layer is developed for use both at playgrounds and at water parks and spray parks. Such layer consists of a thermoplastic foamed thermoplastic olefin, mixed with a urethane binder. By becoming a foamed monolithic surface which is trowelable, one advantage of it is that it does not shrink over time; another is that it is not needed to be put down in individual mats which can later sift and crack at their seams—and thus does not suffer those disadvantages of the prior art. Additionally, a comparable degree of protection as with Styrene Butylene Rubber is provided, yet with a thinner layered surface in a significant cost savings. (An SBR cushion for an HIC of 1000 with a G-Force of 200 that meets American Society For Testing and Materials Standards requires a 3″ cushion. With the thermoplastic olefin urethane composition of the invention, only a 2½″ thickness is required. For a 10,000 square foot playground, for example, a measurable savings of costs can thus be realized. Whereas urethanes when wet deteriorate over time because the water creates an acid base that attacks the polymer chain, in that the surface holds water for months and does not dry out, the thermoplastic foam urethane of the invention does not suffer that disadvantage. Conversely stated, a 3″ thick course layer of the invention would satisfy the ASTM standards for an 8½′ drop whereas a SBR layer would have to be 4″ thick. And because the thermoplastic olefin urethane layer of the invention does not present the same polymer chain that is present with urethane itself, it is not subject to the same acid base that is absorbed even with drying out rain water which creates the degradation of the cushion.

An installation for the playground operation according to the invention, uses the thermoplastic foam cushion base employed as a combination of a foamed thermoplastic olefin, urethane, polyethylene and/or polypropylene ground into small granules which are mixed in a mixer with a liquid urethane, either aromatic or aliphatic. It is then poured out and leveled on to a substrate, and then hand troweled smooth. Once it cures enough to walk on, usually the next day, the wear course layer can be applied. Preferably, the thermoplastic foam cushion base components are ground into granules some 1-3 mm in size—with the underlying substrate sometimes being in the nature of a stone dust or asphalt itself. Although an aromatic urethane is not light stable, when used in this manner under the wear layer of the invention, no difference results as the light does not penetrate to the thermoplastic foamed cushion base to begin with. Being that the base particles are held together by a resin, epoxies or acylics could be used as well.

And with the present invention, any rubber or synthetic turf could be installed over it as the wear course layer and the advantages and benefits of this part of the invention are thereby enjoyed.

Further, in accordance with the invention, a new and improved wear course layer is employed for the alternative recreational water park/spray park facility uses. This layer consists of a thermoplastic rubber, part of the Styrene Elastomer family having both the characteristics of rubber and plastic. For these uses, their characteristic of good tear strength, dimensional stability, weather resistance, reusability and recyclability are highly desirable—along with their being colorable, non-shrinkable, of light weight, ultraviolet light resistant—and of major importance, chlorine resistant for its employment at these water recreational locales.

Once the thermoplastic olefin foam cushion base has cured enough to walk on, usually the next day, this wear course of colorable rubber is applied on to the base in about ⅜″ to ½″ thickness, and then troweled smooth. The resultant safety surface material of the invention in this respect is all seamless, with the binder holding everything together in one continuous carpet-like setting. A hard surface singular mass results, with the moisture in the air finishing the reaction. The result is a totally seamless surface—which could even be used as a base for synthetic turf as at an athletic stadium. And, to install at an existing site—whether it be a playground, a swimming pool or a spray park—all that becomes necessary is to trowel the base cushion down, and when it is cured, layering it over with the thermoplastic rubber wear layer—whether the substrate underneath be of a stone base, asphalt or concrete composition.

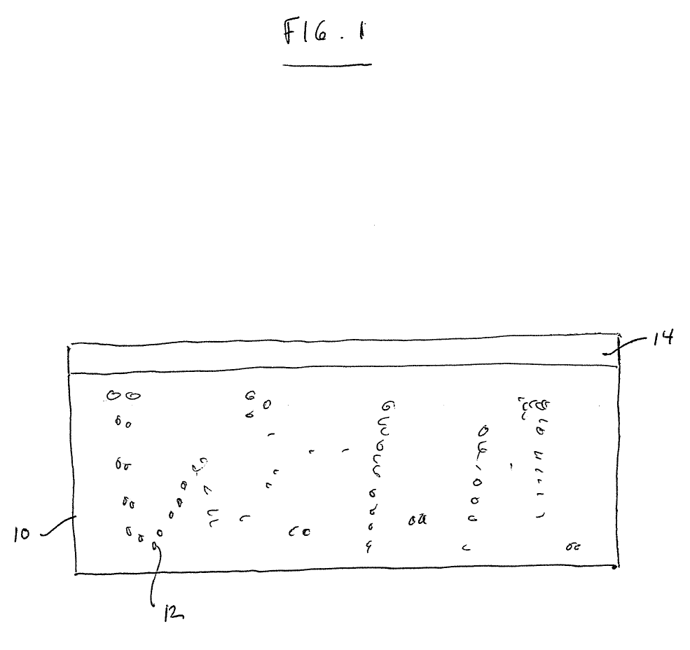

These features of the invention are illustrated by the Block Diagram of FIG. 1, showing the thermoplastic foamed cushion base combination of thermoplastic olefin, urethane, polyethylene and/or polypropylene 10 ground up into small granules 12 and mixed with a liquid urethane either aromatic or aliphatic. The base layer is then covered with the thermoplastic rubber 14 that is light stable and mixed with an aliphatic chlorine resistant liquid urethane for water park/spray park use—instead of an EPDM wear layer or other thermoplastic vulcanized layer as might be used at a playground although providing less beneficial results there, or with an appropriate artificial surface for soccer, football, or rugby type fields.

While there have been described what are considered to be preferred embodiments of the present invention, it will readily be appreciated by those skilled in the art that modifications can be made without departing from the scope of the teachings herein. Thus, whereas a 2½″ thickness of the thermoplastic olefin urethane foamed material will satisfy the same ASTM standards as met by a 3″ thickness of the prior art's Styrene Butylene Rubber, different thickness may be required in the future as equipments and/or uses grow in height or activity; similarly, while the thermoplastic rubber wear layer for water park usage is presently believed sufficient of a ⅜″-½″ layer, so, too, would those thicknesses be increased for more strenuous activities at water park locations other than just running around under spray-type equipment and apparatus. For at least such reasons, therefore, resort should be had to the claims appended hereto for a true understanding of the invention.

I claim:

1. A recreational facility substrate surfacing material comprising:
a cushion base course layer and an overlying wear course layer, wherein the cushion base course layer is characterized by having a chemical resistance to acids, bases and aqueous media, and exhibits a combination of stiffness, impact resistance and dimensional stability.

2. The surfacing material of claim 1 wherein the wear course layer is composed of rubber or synthetic turf.

3. The surfacing material of claim 1 wherein said cushion base course layer is a thermoplastic olefin.

4. The surfacing material of claim 2 wherein the cushion base course layer is a thermoplastic olefin.

5. The surfacing material of claim 1 wherein said wear course layer is characterized by having excellent abrasion and weather resistance and dimensional stability, is light weight, non-shrinkable and exhibits a meaningful tear strength.

6. The surfacing material of claim 5 wherein the wear course layer is also ultraviolet light and chlorine resistant.

7. The surfacing material of claim 6 wherein said cushion base course layer is a thermoplastic olefin.

8. The surfacing material of claim 6 wherein said wear course layer is a thermoplastic rubber.

9. The surfacing material of claim 7 wherein said wear course layer is a thermoplastic rubber.

10. The surfacing material of claim 9 wherein said cushion base course layer is of a thickness of 2½″-4″.

11. The surfacing material of claim 9 wherein said wear course layer is of a thickness ⅜″-½″.

12. The surfacing material of claim 10 wherein said wear course layer is of a thickness ⅜″-½″.

13. The surfacing material of claim 12 wherein each of said cushion base course layer and said overlying wear course layer are monolithically trowelable.

14. The surfacing material of claim 1 wherein said cushion base course layer is a thermoplastic olefin with a urethan binder.
